(19) United States
(12) Patent Application Publication
(10) Pub. No.: US 2008/0283785 A1
(43) Pub. Date: Nov. 20, 2008

(54) Sanitary Fitting

(76) Inventor: Horst Kunkel, Stuttgart (DE)

Correspondence Address: FACTOR & LAKE, LTD, 1327 W. WASHINGTON BLVD., SUITE 5G/H, CHICAGO, IL, 60607, US

(21) Appl. No.: 11/662,720

(22) PCT Filed: Aug. 20, 2005
(86) PCT No.: PCT/EP2005/009014

§ 371 Date: Jan. 16, 2008

(30) Foreign Application Priority Data
Sep. 20, 2004 (DE) 10 2004 045 489.2

(51) Int. Cl. F16K 31/02

(52) U.S. Cl. 251/129.04

(57) ABSTRACT

The invention relates to a sanitary fitting which comprises at least one actuating element (10, 20, 30) for actuating the sanitary fitting. Said actuating element comprises a contactless or contact-sensitive sensor (13, 23, 33) arranged inside or below a transparent cover (12, 22, 32). A display device (14, 24, 34) is mounted below said cover and is controlled by a control device (15, 25, 35) in such a manner that it changes its display status when the actuating element (10, 20, 30) is actuated, thereby confirming actuation.

The invention relates to a sanitary fitting with at least one actuating element for actuating the sanitary fitting, which element has a sensor of a contactless or contact-sensitive nature.

Sanitary fittings such as e.g. taps are known that are actuated via one or more actuating elements of a contactless or contact-sensitive nature. On such sanitary fittings, actuating elements with sensors are used, the sensitivity of which is adjusted in each case so that they respond at the approach of a hand, thus operate contactlessly, or only respond when the housing of the sanitary fitting is actually touched, thus operate contact-sensitively.

Depending on the type of operation, such as e.g. turning on/off, adjusting the water temperature or water quantity etc., a certain period of time exists between actuation of the actuating element and the effect of actuation on the operating status of the sanitary fitting, thus the actual turning on or off of the water outflow or a change in water temperature or water quantity. This period of time can be longer than the reaction time of the user and this can induce the user to actuate the actuating element afresh. Such multiple actuation then leads to undesirable results, however.

An object of the present invention, therefore, is to specify a sanitary fitting with at least one actuating element of a contactless or contact-sensitive nature, in the case of which fitting the risk of multiple actuation by a user is reduced.

The object is achieved by a sanitary fitting with the features of claim 1. Advantageous configurations can be inferred from the dependent claims.

According to the invention, the sanitary fitting comprises at least one actuating element for actuating the sanitary fitting, which element contains a sensor of a contactless or contact-sensitive nature arranged inside or below a transparent cover. A display device is provided below the cover and is controlled by a control device in such a manner that it changes its display status when the actuating element is actuated, thereby confirming actuation.

Each effective actuation of the actuating element is thereby displayed optically to the user. It is therefore no longer attempted to actuate the actuating element repeatedly if the desired success takes a certain period of time to materialize. By arranging the actuating element and the display device in spatial proximity below a common transparent cover, a change in the display status is intuitively understood immediately by a user as an acknowledgement signal for effective actuation.

Reliable actuation is therefore easily possible even for unpractised users.

The display device is preferably an illuminated device, which changes its illuminated status on actuation of the actuating element. This facilitates reliable actuation even in poor light conditions.

The display device advantageously contains an electroluminescent film. Such films are durable, easy to maintain, space-saving and can be integrated into virtually any construction. Further advantages of electroluminescent films are their low weight and the low generation of heat. They are also insensitive to vibration and pressure and have a low power consumption. Electroluminescent films can be configured in practically any shape. Different sections can also be operated independently of one another via separately routed supply lines.

Alternatively, the display device can contain at least one light-emitting diode. Light-emitting diodes are durable, cheap and easy to control. There are also multicoloured light-emitting diodes, which can light red or green, for example. Such a multicoloured light-emitting diode can advantageously be controlled such that it lights in one colour, e.g. green, when the actuating element has not been actuated, and thus signals intuitively to the user that he can actuate the actuating element, and following actuation it lights for a short time in another colour, e.g. red, and thus signals to the user that he has actuated the actuating element successfully and for the time being no renewed actuation is necessary or even possible.

In an advantageous configuration the actuating element is formed as a capacitance sensor and comprises a conductive coating applied to the inside of the transparent cover. This facilitates a particularly space-saving construction, proves to be very reliable in operation and permits production of the sanitary fitting at low cost and with little technical complexity.

In such an execution the conductive coating can expediently be connected electrically to the control device via an electrically conductive elastomer part attached to the inside of the cover and a spring contact fitted on a printed circuit board. This facilitates a secure and non-ageing contact even under hard conditions of use in much-used sanitary facilities.

The actuating element is advantageously formed as an inlaid part that is embedded in the transparent cover. It is thus protected especially well against corrosion due to the effect of moisture.

The display device is preferably arranged on a printed circuit board, on the upper or lower surface of which the control device is also attached and is wired electrically to the display device via printed conductors situated on the circuit board. The use of printed circuit boards both as carriers for control device and display device and for their electrical wiring permits simple and cost-efficient manufacture and proves to be very reliable in operation.

Three practical examples of the invention are explained in greater detail below with reference to the drawings.

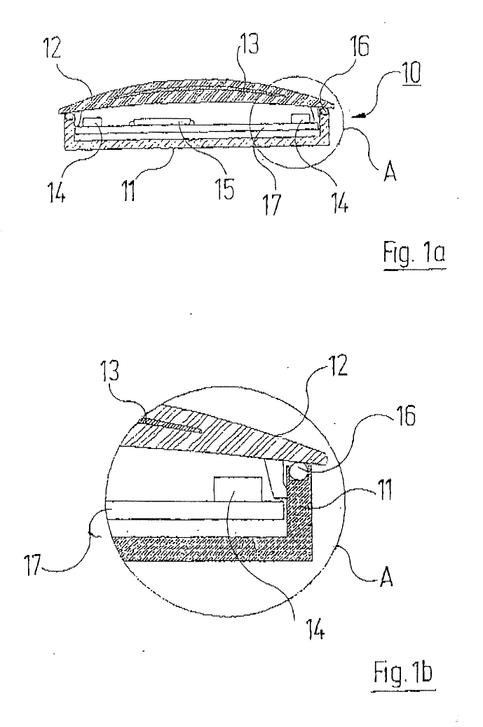

FIG. 1a shows a first practical example of an actuating element with display device for a sanitary fitting in section,

FIG. 1b shows a detailed view of section A from FIG. 1a,

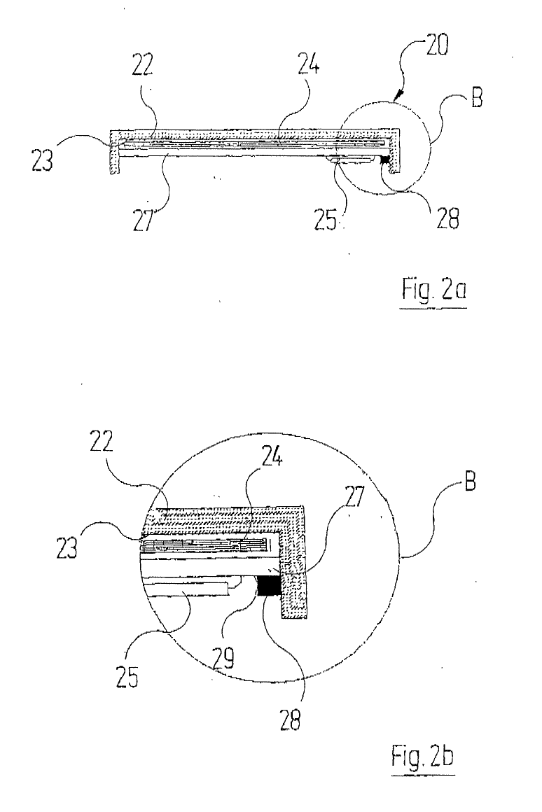

FIG. 2a shows a second practical example of an actuating element with display device for a sanitary fitting in section,

FIG. 2b shows a detailed view of section B from FIG. 2a,

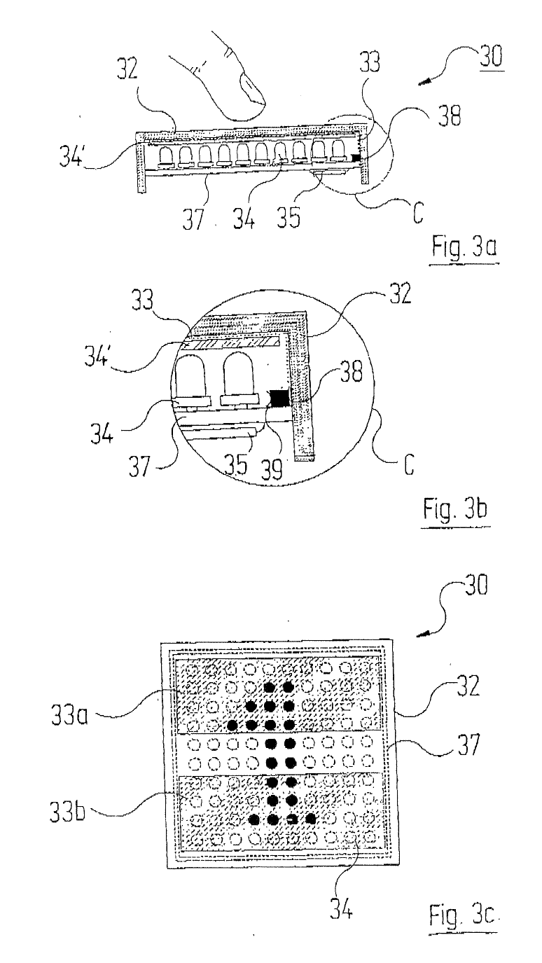

FIG. 3a shows a third practical example of an actuating element with display device for a sanitary fitting in section,

FIG. 3b shows a detailed view of section C from FIG. 3a,

FIG. 3c shows a top view of the actuating element from FIG. 3a, and

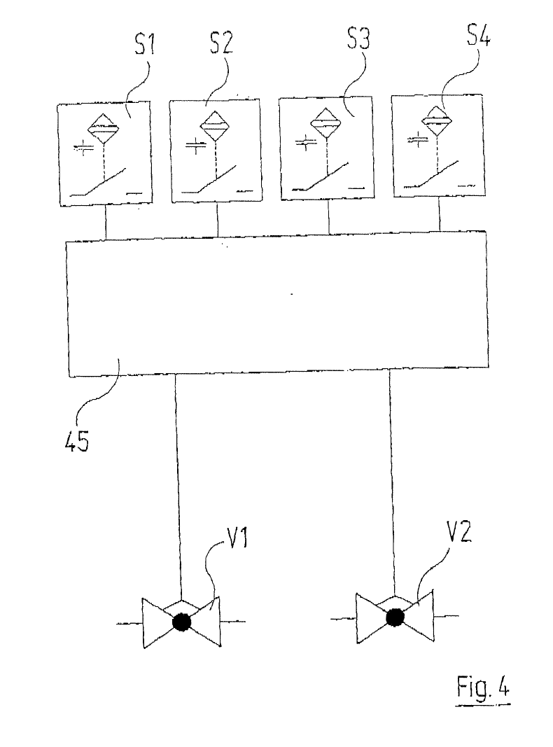

FIG. 4 shows an example of a circuit arrangement for the actuation of a sanitary fitting via four actuating elements of a contactless or contact-sensitive nature.

FIG. 1a shows an actuating element 10 for a sanitary fitting. A section A of FIG. 1a is shown enlarged in FIG. 1b. Attached to a basic body 11 with a circular profile, which is mounted as a head piece on the sanitary fitting, is a transparent cover 12. A seal 16 is located between cover 12 and basic body 11. A sensor 13 of a contactless nature formed as an inlaid part is embedded in the cover 12. Situated below the cover is a printed circuit board 17, on which an annular array of light-emitting diodes 14 and a microprocessor 15 are arranged. The light-emitting diodes 14 are situated at the edge of the cover 12, so that they are not obscured by the centrally arranged sensor 13.

The sensor 13 is connected to the printed circuit board 17 by very thin and therefore practically invisible contact wires, which are not shown. Sensor 13, microprocessor 15 and light-emitting diodes 14 are connected electrically to one another via printed conductors arranged on the printed circuit board 17.

The microprocessor 15 is used to control the sanitary fitting. If the sensor 13 detects a hand, for example, approaching the cover 12, the microprocessor opens an electrically actuated valve in the sanitary fitting and thus releases a flow of water. In addition to this, the microprocessor 15 also controls the light-emitting diodes 14 such that they light up as a reaction to an approach to the cover 12 detected by the sensor 13 and thus signal the effective actuation to the user.

Instead of a simple light-emitting diode 14, a two-coloured light-emitting diode, for example with red and green colour, can also be used. This can be controlled such that it lights green, for example, in the ready-to-operate state and as a reaction to an approach to the cover 12 detected by the sensor 13 changes from green to red as a signal for effective actuation.

A second practical example of an actuating part 20 according to the invention for a sanitary fitting is shown in FIG. 2a. A section B is shown enlarged in FIG. 2b. An electroluminescent film 24 is situated below a cover 22 of glass as a display device. Applied to the inside of the cover 22 is a conductive coating 23, which serves as capacitance sensor to detect touching of the cover 22. Located below the electroluminescent film 24 is a printed circuit board 27, which bears a microprocessor 25 on its lower side. The conductive coating 23 is connected to the circuit board 27 via a spring contact 29 fitted on the circuit board and an electrically conductive elastomer part 28 attached to the inside of the cover 22. The conductive elastomer part 28 and the spring contact 29 ensure a vibration-proof electrical contact.

In order not to obscure the electroluminescent film 24, the conductive coating 23 is either perforated or is itself transparent.

A capacitance sensor generally comprises two electrodes, between which the capacitance is measured. Approaching the electrodes changes the permeability in the vicinity of the electrodes and thus the capacitance of the sensor. In the present case, the two electrodes are formed by the conductive coating 23, which is divided for this purpose into two sections. The microprocessor 25 evaluates a change in capacitance between the two sections of the conductive coating 23 caused by touching the cover 22 and controls a function of the sanitary facility explained further below. At the same time, the microprocessor 25 controls the electroluminescent film 24 such that this changes its illumination status.

The electroluminescent film 24 is a thin film that is excited to illumination by the application of a voltage. The light source constructed as a flat capacitor is formed by a multiple coating on a polyester film acting as a carrier. The basic principle is a semiconductor phenomenon. Electrons are raised to a higher energy level by means of an alternating voltage and recombine in the visible range. Electroluminescent films are so-called Lambert radiators, i.e. they emit an approximate monochromatic light, which is distributed over the entire surface perfectly evenly.

The electroluminescent film 24 is operated using an alternating voltage of between 125 V and 180 V at a frequency between 200 Hz and 1000 Hz. The alternating voltage is obtained from an input voltage of 9-24 VDC using a small DC/AC converter (not shown).

In a third practical example shown in FIG. 3a finally, a printed circuit board 37 with a light-emitting diode panel 34 arranged thereon is located below a cover 32 of glass. FIG. 3b shows an enlarged representation of section C. A conductive coating 33 is applied once again to the inside of the glass cover 32 and is connected to the circuit board 37 via an electrically conductive elastomer part 38 attached to the inside of the cover 32 and a spring contact 39 fitted with the circuit board. A diffusing screen 34′ is additionally arranged between the light-emitting diode panel 34 and cover 32. Located once again on the lower side of the circuit board 35 is a microprocessor, which evaluates the capacitance of the electrodes formed by the conductive coating 34, controls a function of the sanitary fitting in the event of a change in the capacitance and changes the illumination status of the light-emitting diode panel 34 as confirmation.

FIG. 3c shows a top view of the actuating element 30. The light-emitting diode panel 34 arranged on the printed circuit board 37 below the transparent cover 32 consists of 10×10 light-emitting diodes, which are controlled individually by the microprocessor 35. Different characters or numbers can thereby be displayed, like the number 1 shown by way of example in FIG. 3c. Thus the operating status of the sanitary fitting can also be represented using the light-emitting diode panel 34. For example, the water quantity or the water temperature can thus be displayed with a scale from 0 to 9 and changed on each actuation by +/−1. In FIG. 3c the two sections 33a and 33b of the conductive coating 33 are also shown, which sections serve as electrodes of the capacitance sensor. The conductive coating is transparent, in order not to obscure the light-emitting diode panel 34.

Various sensor-controlled functions of a sanitary fitting are shown in FIG. 4 in a block diagram. A microprocessor 45 is shown, to which four sensors S1, S2, S3, S4 of a contactless or contact-sensitive nature are connected on the input side. At two outputs the microprocessor 45 controls two electrically operated valves V1 and V2, which operate in an analog manner. Valve V1 is used as a hot water quantity valve and valve V2 as a cold water quantity valve of a mixer in the sanitary fitting. Sensor S1 is used to increase and sensor S2 to reduce the water temperature, sensor S3 to increase and sensor S4 to reduce the water quantity. The microprocessor 45 controls the flow of water through the two valves V1 and V2 in small increments. If sensor S1 is actuated, for example, corresponding to an increase in the water temperature, the microprocessor opens the hot water quantity valve V1 by an increment and at the same time closes the cold water quantity valve V2 by an increment. The quantity of water thereby remains constant, but the water temperature of the mixed water jet is increased. A reduction in the water temperature functions correspondingly on actuation of sensor S2. On actuation of the sensors S3 and S4, both valves V1 and V2 are respectively opened or closed by one increment, in order thus to increase or reduce the quantity of water flowing out of the sanitary fitting.

As in the practical examples, capacitance sensors can be used as sensors. Alternatively, however, other sensors such as e.g. infrared sensors can also be used. It goes without saying that several sensors can also be arranged below one cover.

1. A sanitary fitting with at least one actuating element for actuating the sanitary fitting, which element comprises a sensor of a contactless or contact-sensitive nature, wherein
the sensor is arranged inside or below a transparent cover and that below the transparent cover a display device is provided, which is controlled by a control device in such a manner that on effective actuation of the actuating element it changes its display status as confirmation of the actuation.

2. The sanitary fitting of claim 1, wherein the display device is an illuminated device, which on actuation of the actuating element changes its illumination status.

3. The sanitary fitting of claim 1, wherein the display device has an electroluminescent film.

4. The sanitary fitting of claim 1, wherein the display device comprises at least one preferably multicoloured light-emitting diode.

5. The sanitary fitting of claim 1, wherein the sensor is formed as a capacitance sensor and comprises a conductive coating applied to the inside of the transparent cover.

6. The sanitary fitting of claim 5, wherein the conductive coating is connected electrically to the control device via at least one electrically conductive elastomer part attached to the inside of the cover and a spring contact fitted on a circuit board.

7. The sanitary fitting of claim 1, wherein the actuating element is formed as an inlaid part that is embedded in the transparent cover.

8. The sanitary fitting of claim 1, wherein display device is arranged on a printed circuit board, to the upper or lower side of which the control device is also attached and is electrically wired to the display device via printed conductors situated on the circuit board.
